(19) United States
(12) Patent Application Publication
(10) Pub. No.: US 2014/0102429 A1
(43) Pub. Date: Apr. 17, 2014

(54) INLET MANIFOLD WITH DUAL PORT EGR

(71) Applicant: GM GLOBAL TECHNOLOGY OPERATIONS LLC, Detroit, MI (US)

(72) Inventors: Alan W. Hayman, Romeo, MI (US); Robert S. McAlpine, Lake Orion, MI (US)

(73) Assignee: GM GLOBAL TECHNOLOGY OPERATIONS LLC, Detroit, MI (US)

(21) Appl. No.: 13/650,519

(22) Filed: Oct. 12, 2012

(51) Int. Cl. F02M 25/07

(52) U.S. Cl. 123/568.18

(57) ABSTRACT

An inlet manifold comprises a plenum, a pair of intermediate runners, and two pair of terminal runners. A common EGR passage is in fluid communication with a pair of EGR injectors, each being in fluid communication with a respective intermediate runner. Each intermediate runner receives a split stream of EGR from its respective EGR injector and combines the split stream of EGR with a split stream of inlet air from the plenum to form an EGR-loaded stream. Each intermediate runner is in fluid communication a pair of terminal runners for distributing its EGR-loaded stream among the terminal runners.

### FIELD OF THE INVENTION

Exemplary embodiments of the invention relate to inlet manifolds for internal combustion engines and, more particularly, to an inlet manifold for an in-line four-cylinder internal combustion engine, wherein a common EGR passage is split to distribute EGR to a pair of intermediate inlet runners, and wherein each of the intermediate inlet runners split to form four terminal inlet runners, each carrying a relatively consistent proportion of EGR.

### BACKGROUND

With the increased focus on vehicle economy, particularly vehicle fuel economy, automotive manufacturers are turning to smaller, lighter vehicles and unique vehicle powertrains to boost efficiency. Recirculated exhaust gas (“EGR”) is utilized in most conventional internal combustion engines to assist in the reduction of throttling losses at low loads, and to improve knock tolerance and reduce the level of oxides of nitrogen (“NOx”) in the exhaust gas at high engine loads. EGR is especially important as an emissions reducer in internal combustion engines that run lean of stoichiometry and thereby are prone to emitting higher levels of NOx emissions. Many engine designs now call for increased rates of flow of exhaust gas recirculation to improve fuel economy.

Unfortunately, it can be challenging for an engine designer to meet such demands for increased EGR flow levels within the geometric constraints that are often imposed by small engine architecture without negatively impacting the EGR flow balance from cylinder to cylinder. Large EGR delivery volumes typically call for large intake manifold volumes, which correspond to increased weight and cost while slowing engine throttle response and EGR response. In addition, packaging issues tend to cause the EGR control valve to be positioned in relatively close proximity to the throttle body. As a result, throttle body icing issues may also affect the EGR control system. Packaging issues can also lead to intake airflow imbalances and EGR delivery imbalances between runners. Such EGR delivery imbalances, particularly with EGR delivery systems providing a dedicated EGR delivery passageway for each individual cylinder, can cause issues with engine diagnostic systems.

Accordingly, it is desirable to have an inlet manifold that provides improved EGR delivery capabilities for improved fuel economy.

### SUMMARY

In an exemplary embodiment, an inlet manifold comprises a plenum for receiving inlet air. A first intermediate runner is in fluid communication with the plenum for receiving a first portion of the inlet air to form a first split stream of inlet air in the first intermediate runner. A second intermediate runner is in fluid communication with the plenum for receiving a second portion of the inlet air to form a second split stream of inlet air in the second intermediate runner. A common EGR passage is disposed for receiving EGR from an EGR source. A first EGR injector is in fluid communication with the common EGR passage for receiving a first portion of the EGR to form a first split stream of EGR in the first EGR injector. A second EGR injector is in fluid communication with the common EGR passage for receiving a second portion of the EGR to form a second split stream of EGR in the second EGR injector.

The first intermediate runner is in fluid communication with the first EGR injector for receiving the first split stream of EGR from the first EGR injector and combining the first split stream of EGR with the first split stream of inlet air to form a first EGR-loaded stream. The second intermediate runner is in fluid communication with the second EGR injector for receiving the second split stream of EGR and combining the second split stream of EGR with the second split stream of inlet air to form a second EGR-loaded stream. The first intermediate runner is in fluid communication with a first terminal runner and a second terminal runner for distributing the first EGR-loaded stream among the first terminal runner and a second terminal runner. The second intermediate runner is in fluid communication with a third terminal runner and a fourth terminal runner for distributing the second EGR-loaded stream among the third terminal runner and the fourth terminal runner.

In another exemplary embodiment, an internal combustion engine comprises four engine cylinders, a cylinder head, and an inlet manifold. The engine cylinders are arranged in an in-line configuration, each engine cylinder having a piston disposed therein for extracting work through an internal combustion process performed in the cylinder. The cylinder head defines four inlet ports, each inlet port being in fluid communication with a respective one of the four engine cylinders. The inlet manifold comprises a plenum for receiving inlet air. A first intermediate runner is in fluid communication with the plenum for receiving a first portion of the inlet air to form a first split stream of inlet air in the first intermediate runner. A second intermediate runner is in fluid communication with the plenum for receiving a second portion of the inlet air to form a second split stream of inlet air in the second intermediate runner.

A common EGR passage is disposed for receiving EGR from an EGR source. A first EGR injector is in fluid communication with the common EGR passage for receiving a first portion of the EGR to form a first split stream of EGR in the first EGR injector. A second EGR injector is in fluid communication with the common EGR passage for receiving a second portion of the EGR to form a second split stream of EGR in the second EGR injector. The first intermediate runner is in fluid communication with the first EGR injector for receiving the first split stream of EGR from the first EGR injector and combining the first split stream of EGR with the first split stream of inlet air to form a first EGR-loaded stream. The second intermediate runner is in fluid communication with the second EGR injector for receiving the second split stream of EGR and combining the second split stream of EGR with the second split stream of inlet air to form a second EGR-loaded stream.

The first intermediate runner is in fluid communication with a first terminal runner and a second terminal runner for distributing the first EGR-loaded stream among the first terminal runner and the second terminal runner. The second intermediate runner is in fluid communication with a third terminal runner and a fourth terminal runner for distributing the second EGR-loaded stream among the third terminal runner and the fourth terminal runner. The first terminal runner, the second terminal runner, the third terminal runner and the fourth terminal runner are each in fluid communication with a respective one of the four inlet ports.

The above features and advantages, and other features and advantages of the invention are readily apparent from the following detailed description of the invention when taken in connection with the accompanying drawings.

### BRIEF DESCRIPTION OF THE DRAWINGS

Other objects, features, advantages and details appear, by way of example only, in the following detailed description of the embodiments, the detailed description referring to the drawings in which:

FIG. 1 is a schematic drawing of an exemplary inlet manifold with an integrated EGR delivery system;

FIG. 2 is a schematic drawing of an exemplary electronic control for an EGR delivery system as shown in FIG. 1;

FIG. 3 is a schematic drawing of an exemplary inlet manifold with an integrated EGR delivery system;

FIG. 4 is a schematic drawing of an exemplary inlet manifold with an integrated EGR delivery system; and

FIG. 5 is a schematic drawing of an exemplary inlet manifold with an integrated EGR delivery system.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

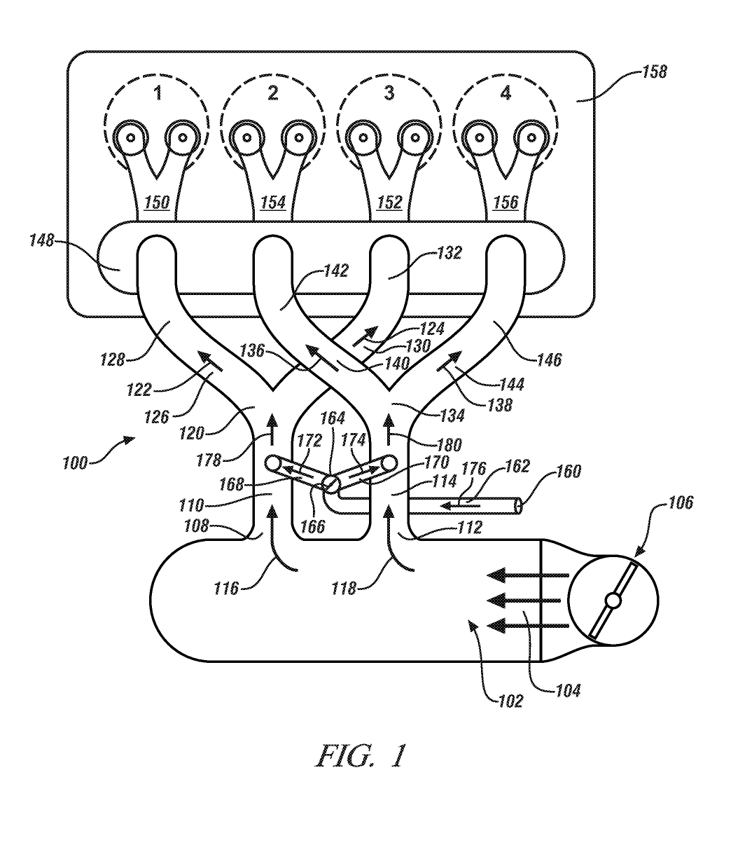

Referring now to FIG. 1, an exemplary embodiment of the invention is directed to an inlet manifold 100 with an integrated EGR delivery system. As shown in FIG. 1, an inlet manifold 100 comprises a plenum 102 that receives inlet air 104 from an electronically controlled throttle body 106. The plenum 102 is in fluid communication with an entry end 108 of a first intermediate runner 110 and an entry end 112 of a second intermediate runner 114. The plenum 102 is sized so as to provide a suitable volume of air to an associated engine at relatively low velocity within the plenum 102 to facilitate low loss of pressure as the inlet air 104 travels through the plenum 102.

At its respective entry end 108, the first intermediate runner 110 receives a first split stream of inlet air 116 from the plenum 102. Similarly, at its respective entry end 112, the second intermediate runner 114 receives a second split stream of inlet air 118 from the plenum 102. In an exemplary embodiment, the plenum is configured for distributing inlet air in substantially equal proportions among the first intermediate runner and the second intermediate runner. To accomplish such equal flow distributions, particularly where it may be necessary to compensate for a non-uniform pressure distribution, flow-path areas and contours may be adjusted based on flow/pressure predictions and/or measurements.

In an exemplary embodiment, the first intermediate runner 110 employs a first inlet splitter 120, which operates to divide the first split stream of inlet air 116 into a first terminal inlet stream 122 and a second terminal inlet stream 124. A first downstream leg 126 of the first inlet splitter 120 is in fluid communication with, and delivers the first terminal inlet stream 122 to, a first terminal runner 128. A second downstream leg 130 of the first inlet splitter 120 is in fluid communication with, and delivers the second terminal inlet stream 124, to a second terminal runner 132. In an exemplary embodiment, the first intermediate runner is configured for distributing its carried flow (i.e., the first split stream of inlet air 116 mixed with EGR 176 as discussed below) in substantially equal proportions among the first terminal runner 128 and the second terminal runner 132. To accomplish such equal flow distributions, particularly where it may be necessary to compensate for a non-uniform pressure distribution, flow-path areas and contours may be adjusted based on flow/pressure predictions and/or measurements.

The second intermediate runner 114 employs a second inlet splitter 134, which operates to divide the second split stream of inlet air 118 into a third terminal inlet stream 136 and a fourth terminal inlet stream 138. A third downstream leg 140 of the second inlet splitter 134 is in fluid communication with, and delivers the third terminal inlet stream 136 to, a third terminal runner 142. A fourth downstream leg 144 of the second inlet splitter 134 is in fluid communication with, and delivers the fourth terminal inlet stream 138, to a fourth terminal runner 146. In an exemplary embodiment, the second intermediate runner 114 is configured for distributing its carried flow (i.e., the second split stream of inlet air 118 mixed with EGR 176 as discussed below) in substantially equal proportions among the third terminal runner 142 and the fourth terminal runner 146. To accomplish such equal flow distributions, particularly where it may be necessary to compensate for a non-uniform pressure distribution, flow-path areas and contours may be adjusted based on flow/pressure predictions and/or measurements.

The first, second, third, and fourth terminal runners 128, 132, 142, 146, each terminate at a cylinder head mounting flange 148 in such position as to facilitate fluid communication between each terminal runner 128, 132, 142, 146 and a respective intake port 150, 152, 154, 156 of a cylinder head 158 when the inlet manifold 100 is fixed to the cylinder head 158 (e.g., via the cylinder head mounting flange 148). Each terminal runner 128, 132, 142, 146 is sized and configured so as to carry a suitable charge of combustion air to supply the needs of its associated cylinder 1, 3, 2, 4. The charge of combustion air comprises air drawn from the plenum 102 and EGR 176 supplied by an EGR source 160. EGR source 160 is typically an engine exhaust system (not shown). EGR 176 is carried from the EGR source 160 by a common EGR passage 162, within which an EGR flow control system 164 controls the flow of EGR 176.

It should be noted that each intake port 150, 152, 154, 156 is in fluid communication with an associated engine cylinder 1, 2, 3, 4 of the engine. In the illustrated embodiment, the engine cylinders are arranged in an in-line configuration, and it is understood that each engine cylinder has a piston (not shown) disposed therein for extracting work through an internal combustion process performed in the engine cylinder. It is understood that an engine rotating group (not shown) includes a crankshaft (not shown) coupled to the pistons (not shown). The geometry of the crankshaft (not shown) determines the order of events occurring during the aforementioned internal combustion process. For example, crankshaft geometry determines the timing and order of intake events occurring in the cylinders of the engine bank. As shown in FIG. 1, an in-line bank of engine cylinders includes two external cylinders 1, 4 and two internal cylinders 2, 3. External cylinder 1 is adjacent to internal cylinder 2 and is non-adjacent to internal cylinder 3. External cylinder 4 is adjacent to internal cylinder 3 and is non-adjacent to internal cylinder 2.

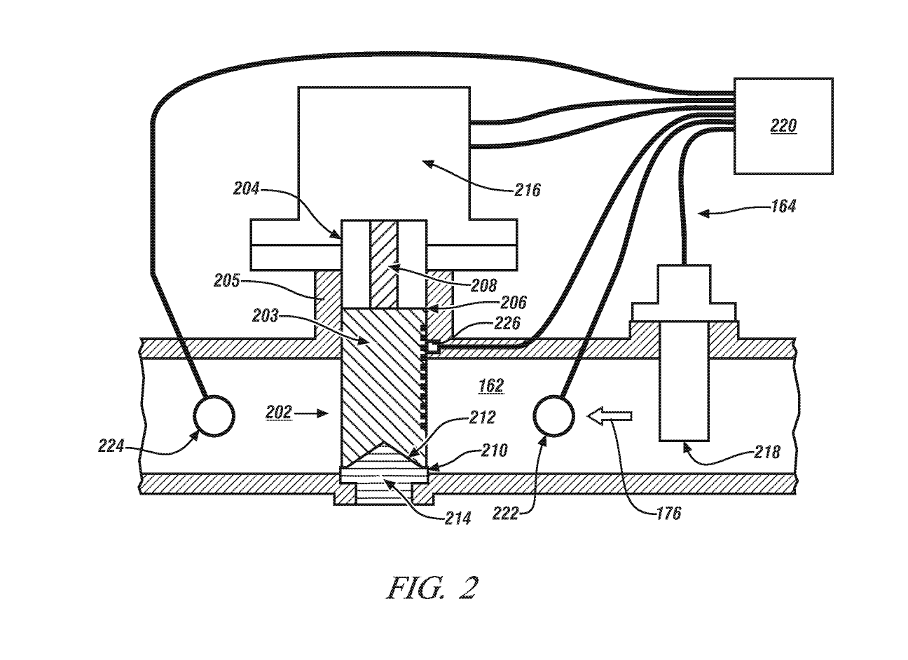

In an exemplary embodiment, as shown in FIG. 2, an EGR flow control system 164 is disposed in the common EGR passage 162 and comprises a flow control valve 202, which, in the illustrated embodiment, includes a flow control piston 203 disposed in a piston bore 204 defined by a flow control housing 205. It should be appreciated that other metering valve configurations are possible such as a butterfly valve. The flow control valve 202 is moveable within the flow control housing 205 (e.g., the flow control piston 203 is movable within the piston bore 204) through a range of positions corresponding to a desirable range of flow rates of the EGR 176 for the particular application in which the EGR flow control system 164 is employed. At a first end 206, the flow control valve 202 is coupled to a shaft 208 or other structure configured for moving the flow control valve 202 through its range of positions. At a second end 210, the flow control valve 202 is shaped so as to define a surface 212 that is configured to cooperate with the shape of an insert 214 (when the flow control valve 202 is in a closed position) to provide a seal that substantially stops the flow of EGR 176 in the common EGR passage 162. The insert 214 may be shaped so as to inhibit accumulation of soot or other contaminants carried by the EGR 176. In an exemplary embodiment, the shaft 208 is coupled to and driven by an electric motor 216.

In the common EGR passage 162, a temperature sensor 218 senses and provides temperature signals to an engine controller 220. Also in the common EGR passage 162, an upstream pressure sensor 222 and a downstream pressure sensor 224 sense and provide upstream (relative to the flow control valve 202) and downstream (relative to the flow control valve 202) pressure signals to the engine controller 220. A piston position sensor 226 senses and provides signals indicating position of the flow control valve 202 to the engine controller 220. Based on the upstream and downstream pressure signals, the temperature signal and the piston position signal, the engine controller 220 determines a feedback rate of flow of EGR 176. The engine controller 220 compares the feedback rate of flow of EGR 176 to a desired rate of flow of EGR 176 and actuates the electric motor 216 to move the shaft 208 and the flow control valve 202 to achieve the desired rate of flow of EGR 176 in the common EGR passage 162. Accordingly, flow control valve 202 may be modulated to precisely meet desired rates of flow for EGR 176.

With further reference to FIG. 1, at a downstream end 166 of the common EGR passage 162, the common EGR passage 162 is in fluid communication with, and delivers EGR 176 to, a first EGR injector 168, and a second EGR injector 170. The first EGR injector 168 delivers EGR to the first split stream of inlet air 116, and the second EGR injector 170 delivers EGR 176 to second split stream of inlet air 118. In an exemplary embodiment, the common EGR passage 162 is configured for distributing EGR 176 in substantially equal proportions among the first EGR injector 168 and the second EGR injector 170. To accomplish such equal flow distributions, particularly where it may be necessary to compensate for a non-uniform pressure distribution, flow-path areas and contours may be adjusted based on flow/pressure predictions and/or measurements.

In an exemplary embodiment, as shown in FIG. 1, the first intermediate runner 110 is in fluid communication with the first EGR injector 168, and the second intermediate runner 114 is in fluid communication with the second EGR injector 170. In accordance with this embodiment, within the first intermediate runner 110, a first split stream of EGR 172 is received from the first EGR injector 168 and mixed with the first split stream of inlet air 116 to create a first EGR-loaded stream 178. The first inlet splitter 120 splits the first EGR-loaded stream 178 to create the first terminal inlet stream 122 and the second terminal inlet stream 124. Similarly, within the second intermediate runner 114, a second split stream of EGR 174 is received from the second EGR injector 170 and mixed with the second split stream of inlet air 118 to create a second EGR-loaded stream 180. The second inlet splitter 134 splits the second EGR-loaded stream 180 to create the third terminal inlet stream 136 and the fourth terminal inlet stream 138.

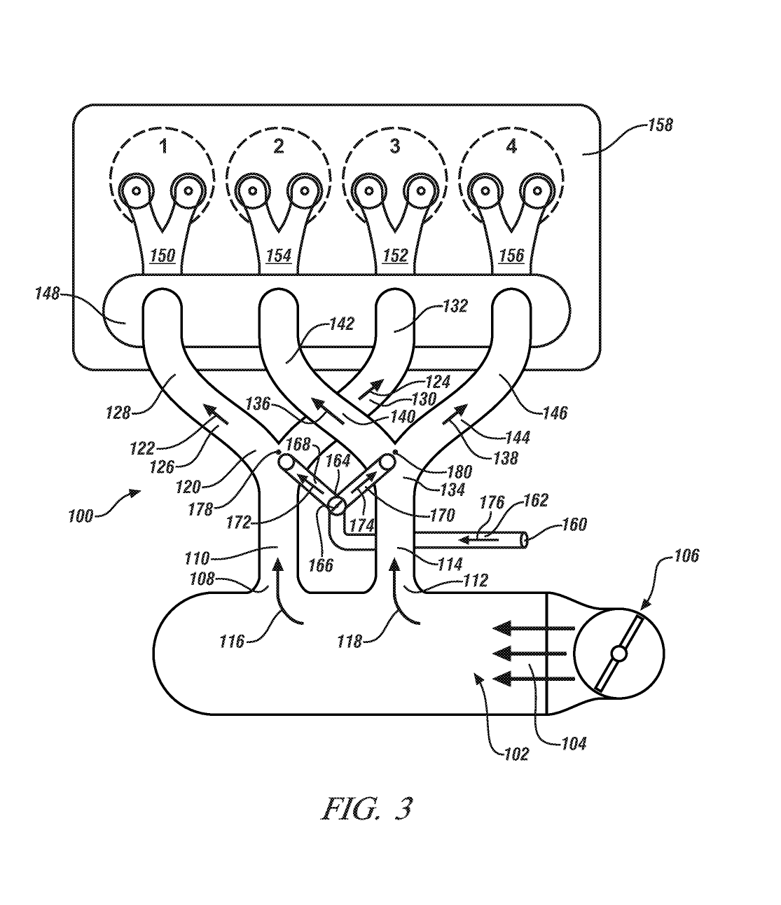

In an alternative embodiment, as shown in FIG. 3, the first inlet splitter 120 is in fluid communication with the first EGR injector 168, and the second inlet splitter 134 is in fluid communication with the second EGR injector 170. In accordance with this embodiment, within the first inlet splitter 120, the first split stream of EGR 172 is received from the first EGR injector 168 and mixed with the first split stream of inlet air 116 to create the first EGR-loaded stream 178. Similarly, within the second inlet splitter 134, the second split stream of EGR 174 is received from the second EGR injector 170 and mixed with the second split stream of inlet air 118 to create the second EGR-loaded stream 180.

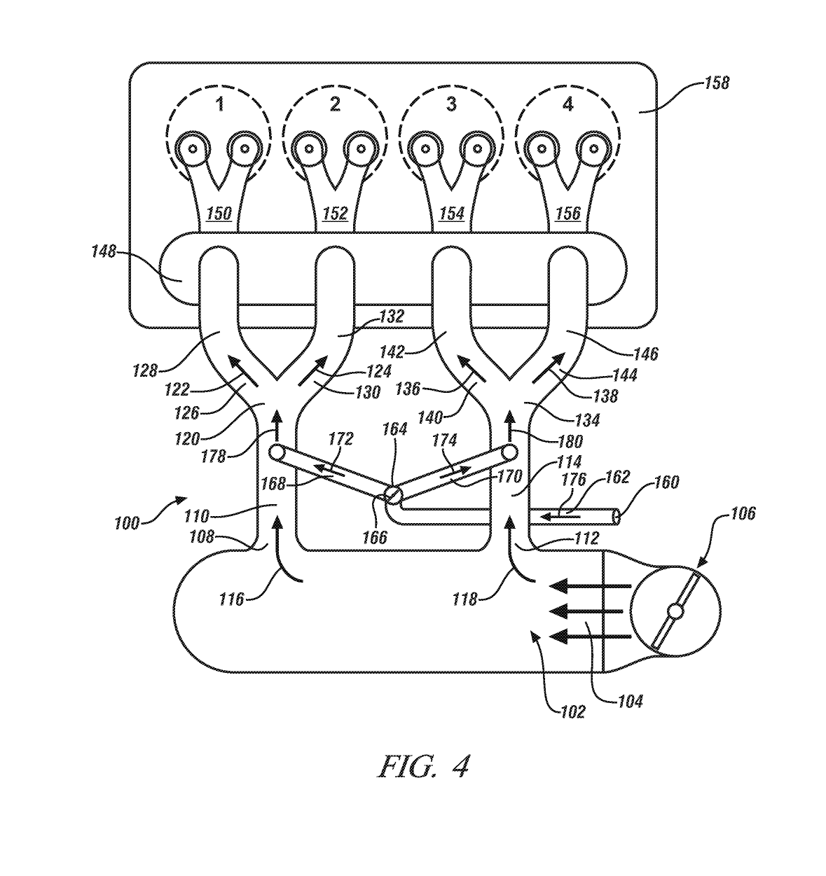

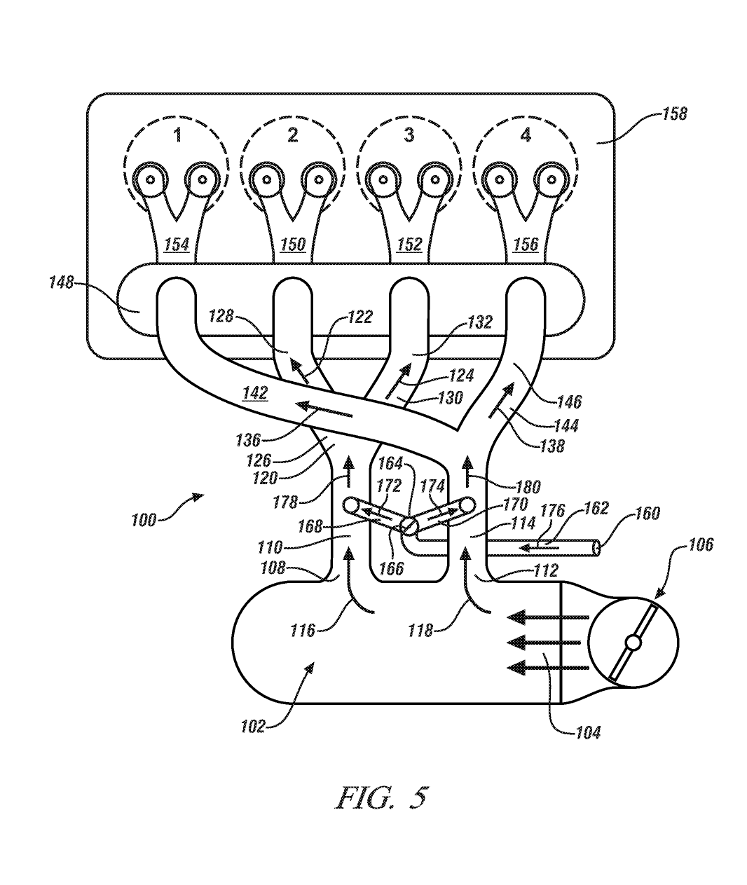

As shown in FIG. 1, FIG. 3, FIG. 4, and FIG. 5, the first terminal runner 128 delivers the first terminal inlet stream 122 to its associated intake port 150, and the second terminal runner 132 delivers the second terminal inlet stream 124 to its associated intake port 152. Similarly, the third terminal runner 142 delivers the third terminal inlet stream 136 to its associated intake port 154, and the fourth terminal runner 146 delivers the fourth terminal inlet stream 138 to its associated intake port 156. In an exemplary embodiment, an engine cylinder associated with intake port 152 (and thus the second terminal runner 132 and the first intermediate runner 110 and the first EGR injector 168) executes its intake events approximately one-half cycle out of phase relative to the engine cylinder associated with intake port 150 (and thus the first terminal runner 128 and the first intermediate runner 110 and the first EGR injector 168). Similarly, an engine cylinder associated with intake port 156 (and thus the fourth terminal runner 146 and the second intermediate runner 114 and the second EGR injector 170) executes its intake events approximately one-half cycle out of phase relative to the engine cylinder associated with intake port 154 (and thus the third terminal runner 142 and the second intermediate runner 114 and the second EGR injector 170).

Accordingly, when paired with an engine wherein the cylinders associated with the first intermediate runner 110 and the first EGR injector 168 execute their intake events at relatively even intervals (i.e., approximately one-half cycle out of phase from one another), the first intermediate runner 110 is configured such that the first EGR-loaded stream 178 (and thus the first split stream of inlet air 116 and the first split stream of EGR 172) carried by the first intermediate runner 110 is alternatingly delivered to the first terminal runner 128 and the second terminal runner 132 at relatively even time intervals, resulting in a relatively steady flow rates of the first split stream of inlet air 116 within the first intermediate runner 110 and the first split stream of EGR 172 within the first EGR injector 168.

Similarly, when paired with an engine wherein the cylinders associated with the second intermediate runner 114 and the second EGR injector 170 execute their intake events at relatively even intervals (i.e., approximately one-half cycle out of phase from one another), the second intermediate runner 114 is configured such that the second EGR-loaded stream 180 (and thus the second split stream of inlet air 118 and the second split stream of EGR 174) that is carried by the second intermediate runner 114 is alternatingly delivered to the third terminal runner 142 and the fourth terminal runner 146 at relatively even time intervals, resulting in a relatively steady flow rates of the second split stream of inlet air 118 within the second intermediate runner 114 and the second split stream of EGR 174 within the second EGR injector 170.

Moreover, when paired with an engine wherein the cylinders associated with the second intermediate runner 114 and the second EGR injector 170 execute their intake events approximately one-quarter cycle out of phase from the cylinders associated with the first intermediate runner 110 and the first EGR injector 168, relatively steady flow rates are experienced within the plenum 102 and the common EGR passage 162.

In accordance with an inlet manifold as shown in FIG. 1 and FIG. 3, the cylinders 1, 2, 3, 4 execute their intake events according to either a 1-2-3-4 firing order or a 1-4-3-2 firing order such that the cylinders associated with the first intermediate runner 110 and the first EGR injector 168 execute their intake events at relatively even intervals (i.e., approximately one-half cycle out of phase from one another), and the cylinders associated with the second intermediate runner 114 and the second EGR injector 170 execute their intake events at relatively even intervals (i.e., approximately one-half cycle out of phase from one another), and the cylinders associated with the second intermediate runner 114 and the second EGR injector 170 execute their intake events approximately one-quarter cycle out of phase from the cylinders associated with the first intermediate runner 110 and the first EGR injector 168.

In accordance with an inlet manifold as shown in FIG. 4, the cylinders 1, 2, 3, 4 execute their intake events according to either a 1-3-2-4 firing order or a 1-4-2-3 firing order such that the cylinders associated with the first intermediate runner 110 and the first EGR injector 168 execute their intake events at relatively even intervals (i.e., approximately one-half cycle out of phase from one another), and the cylinders associated with the second intermediate runner 114 and the second EGR injector 170 execute their intake events at relatively even intervals (i.e., approximately one-half cycle out of phase from one another), and the cylinders associated with the second intermediate runner 114 and the second EGR injector 170 execute their intake events approximately one-quarter cycle out of phase from the cylinders associated with the first intermediate runner 110 and the first EGR injector 168.

In accordance with an inlet manifold as shown in FIG. 5, the cylinders 1, 2, 3, 4 execute their intake events according to either a 1-3-4-2 firing order or a 1-2-4-3 firing order such that the cylinders associated with the first intermediate runner 110 and the first EGR injector 168 execute their intake events at relatively even intervals (i.e., approximately one-half cycle out of phase from one another), and the cylinders associated with the second intermediate runner 114 and the second EGR injector 170 execute their intake events at relatively even intervals (i.e., approximately one-half cycle out of phase from one another), and the cylinders associated with the second intermediate runner 114 and the second EGR injector 170 execute their intake events approximately one-quarter cycle out of phase from the cylinders associated with the first intermediate runner 110 and the first EGR injector 168.

Accordingly, an inlet manifold system for a 4-cylinder engine bank is provided with a symmetric EGR delivery system. A plenum divides an inlet stream into two intermediate streams, and each of those two intermediate streams is subsequently mixed with EGR and divided into two terminal streams, thereby producing four terminal streams, each carrying a relatively consistent proportion of EGR. From an EGR balance perspective, the symmetrical geometry of the disclosed embodiments may mitigate imbalances in EGR across a range of speeds and loads. Since EGR flow rates/volumes may be controlled in close proximity to the point at which EGR is introduced to the intake flow, the volume of intake air to be purged may be decreased so as to improve transient response. As a result increased levels of EGR may be employed without sacrificing engine operability. Since the EGR delivery path may be positioned remotely from the throttle body, icing issues that might otherwise be experienced when locating EGR delivery systems near the throttle body may be avoided. Since EGR is delivered upstream from where inlet flow is to be split for delivery to a plurality of cylinders, diagnostic issues may be avoided or reduced.

In accordance with the disclosed features, increased EGR delivery rates may be enabled, providing for improved fuel economy. At the same time a relatively low EGR delivery volume is required, enabling improved transient response. In addition, the disclosed features facilitate decreased inlet manifold volumes, which may result in improved throttle response and/or elongated runners for a given system volume. The disclosed features facilitate positioning the EGR controls remotely from the intake throttle body, which can be useful in addressing icing issues. In addition, the disclosed features enable improvements in runner flow balance and decreased diagnostic issues.

The invention has been described above primarily with reference to its application in a 4-cylinder engine. It should be clear to one skilled in the art of internal combustion engines that engines of other cylinder numbers (e.g., 8, 12, 16 cylinders) and varied configurations, can easily be envisaged and that the invention should not, and cannot be limited to those examples provided herein.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the present application.

What is claimed is:

1. An inlet manifold for an internal combustion engine, the inlet manifold comprising:
a plenum for receiving inlet air;
a first intermediate runner in fluid communication with the plenum for receiving a first portion of the inlet air to form a first split stream of inlet air in the first intermediate runner;
a second intermediate runner in fluid communication with the plenum for receiving a second portion of the inlet air to form a second split stream of inlet air in the second intermediate runner;
a common EGR passage for receiving EGR from an EGR source;
a first EGR injector in fluid communication with the common EGR passage for receiving a first portion of the EGR to form a first split stream of EGR in the first EGR injector;
a second EGR injector in fluid communication with the common EGR passage for receiving a second portion of the EGR to form a second split stream of EGR in the second EGR injector;
the first intermediate runner being in fluid communication with the first EGR injector for receiving the first split stream of EGR from the first EGR injector and combining the first split stream of EGR with the first split stream of inlet air to form a first EGR-loaded stream;
the second intermediate runner being in fluid communication with the second EGR injector for receiving the second split stream of EGR and combining the second split stream of EGR with the second split stream of inlet air to form a second EGR-loaded stream;
the first intermediate runner being in fluid communication with a first terminal runner and a second terminal runner for distributing the first EGR-loaded stream among the first terminal runner and the second terminal runner; and
the second intermediate runner being in fluid communication with a third terminal runner and a fourth terminal runner for distributing the second EGR-loaded stream among the third terminal runner and the fourth terminal runner.

2. An inlet manifold as in claim 1, wherein the first intermediate runner is configured for distributing the first EGR-loaded stream in substantially equal proportions among the first terminal runner and the second terminal runner.

3. An inlet manifold as in claim 1, wherein the second intermediate runner is configured for distributing the second EGR-loaded stream in substantially equal proportions among the third terminal runner and the fourth terminal runner.

4. An inlet manifold as in claim 1, wherein the plenum is configured for distributing inlet air in substantially equal proportions among the first intermediate runner and the second intermediate runner.

5. An inlet manifold as in claim 1, wherein the common EGR passage is configured for distributing EGR in substantially equal proportions among the first EGR injector and the second EGR injector.

6. An inlet manifold as in claim 1, wherein the common EGR passage includes an EGR flow control system.

7. An inlet manifold as in claim 6, wherein the EGR flow control system comprises a flow control valve controlled by an engine controller that is responsive to a sensed pressure upstream from the flow control valve.

8. An inlet manifold as in claim 6, wherein the EGR flow control system comprises a flow control valve controlled by an engine controller that is responsive to a sensed pressure downstream from the flow control valve.

9. An inlet manifold as in claim 6, wherein the EGR flow control system comprises a flow control valve controlled by an engine controller that is responsive to a sensed valve position.

10. An inlet manifold as in claim 6, wherein the EGR flow control system comprises a flow control valve controlled by an engine controller responsive to a sensed EGR temperature.

11. An inlet manifold as in claim 1, wherein the first terminal runner and the third terminal runner are fixed to a cylinder head mounting flange to facilitate fluid communication between the first terminal runner and an external engine cylinder and between the third terminal runner and an adjacent internal engine cylinder.

12. An inlet manifold as in claim 1, wherein the second terminal runner and the third terminal runner are fixed to a cylinder head mounting flange to facilitate fluid communication between the second terminal runner and an internal engine cylinder and between the third terminal runner and another internal engine cylinder.

13. An inlet manifold as in claim 1, wherein the second terminal runner and the fourth terminal runner are fixed to a cylinder head mounting flange to facilitate fluid communication between the fourth terminal runner and an external engine cylinder and between the second terminal runner and an adjacent internal engine cylinder.

14. An inlet manifold as in claim 1, wherein the first terminal runner and the second terminal runner are fixed to a cylinder head mounting flange to facilitate fluid communication between the first terminal runner and an external engine cylinder and between the second terminal runner and an adjacent internal engine cylinder.

15. An inlet manifold as in claim 1, wherein the second terminal runner and the third terminal runner are fixed to a cylinder head mounting flange to facilitate fluid communication between the second terminal runner and an internal engine cylinder and between the third terminal runner and another internal engine cylinder.

16. An inlet manifold as in claim 1, wherein the third terminal runner and the fourth terminal runner are fixed to a cylinder head mounting flange to facilitate fluid communication between the fourth terminal runner and an external engine cylinder and between the third terminal runner and an adjacent internal engine cylinder.

17. An internal combustion engine comprising:
four engine cylinders arranged in an in-line configuration, each engine cylinder having a piston disposed therein for extracting work through an internal combustion process performed therein;
a cylinder head defining four inlet ports, each inlet port being in fluid communication with a respective one of said four engine cylinders; and
an inlet manifold comprising:
a plenum for receiving inlet air;
a first intermediate runner in fluid communication with the plenum for receiving a first portion of the inlet air to form a first split stream of inlet air in the first intermediate runner;
a second intermediate runner in fluid communication with the plenum for receiving a second portion of the inlet air to form a second split stream of inlet air in the second intermediate runner;
a common EGR passage for receiving EGR from an EGR source;
a first EGR injector in fluid communication with the common EGR passage for receiving a first portion of the EGR to form a first split stream of EGR in the first EGR injector;
a second EGR injector in fluid communication with the common EGR passage for receiving a second portion of the EGR to form a second split stream of EGR in the second EGR injector;
the first intermediate runner being in fluid communication with the first EGR injector for receiving the first split stream of EGR from the first EGR injector and combining the first split stream of EGR with the first split stream of inlet air to form a first EGR-loaded stream;
the second intermediate runner being in fluid communication with the second EGR injector for receiving the second split stream of EGR and combining the second split stream of EGR with the second split stream of inlet air to form a second EGR-loaded stream;
the first intermediate runner in fluid communication with a first terminal runner and a second terminal runner for distributing the first EGR-loaded stream among the first terminal runner and the second terminal runner; and
the second intermediate runner in fluid communication with a third terminal runner and a fourth terminal runner for distributing the second EGR-loaded stream among the third terminal runner and the fourth terminal runner;
wherein the first terminal runner, the second terminal runner, the third terminal runner and the fourth terminal runner are each in fluid communication with a respective one of said four inlet ports.

18. An internal combustion engine as in claim 17:
wherein the internal combustion engine is operated such that an intake event of an external engine cylinder is performed one-half cycle out of phase from an intake event of a non-adjacent internal engine cylinder;
wherein the internal combustion engine is operated such that an intake event of the external engine cylinder is performed one-quarter cycle out of phase from an intake event of an adjacent internal engine cylinder;
wherein the first terminal runner is in fluid communication with the external engine cylinder;
wherein the third terminal runner is in fluid communication with the adjacent internal engine cylinder; and
wherein the second terminal runner is in fluid communication with the non-adjacent internal engine cylinder.

19. An internal combustion engine as in claim 17:
wherein the internal combustion engine is operated such that an intake event of an external engine cylinder is performed one-quarter cycle out of phase from an intake event of a non-adjacent internal engine cylinder;
wherein the internal combustion engine is operated such that an intake event of the external engine cylinder is performed one-half cycle out of phase from an intake event of an adjacent internal engine cylinder;
wherein the first terminal runner is in fluid communication with the external engine cylinder;
wherein the second terminal runner is in fluid communication with the adjacent internal engine cylinder; and
wherein the third terminal runner is in fluid communication with the non-adjacent internal engine cylinder.

20. An internal combustion engine as in claim 17:
wherein the internal combustion engine is operated such that an intake event of an external engine cylinder is performed one-quarter cycle out of phase from an intake event of an adjacent internal engine cylinder;
wherein the internal combustion engine is operated such that an intake event of an adjacent internal engine cylinder is performed one-half cycle out of phase from an intake event of a non-adjacent internal engine cylinder;
wherein the third terminal runner is in fluid communication with the external engine cylinder;
wherein the second terminal runner is in fluid communication with the adjacent internal engine cylinder; and
wherein the first terminal runner is in fluid communication with the non-adjacent internal engine cylinder.
